(19) United States
(12) Patent Application Publication
(10) Pub. No.: US 2020/0144907 A1
(43) Pub. Date: May 7, 2020

(54) Three-Mode Selection Electronically Commuted Motor

(71) Applicant: Inergy Technology Inc., Hsinchu County (TW)

(72) Inventors: Chorng-Wei Liaw, Hsinchu County (TW); Hsien-Wen Hsu, Hsinchu County (TW); Ying-Chieh Lin, New Taipei City (TW)

(21) Appl. No.: 16/654,021

(22) Filed: Oct. 16, 2019

Related U.S. Application Data
(60) Provisional application No. 62/754,498, filed on Nov. 1, 2018.

(51) Int. Cl. H02M 1/44; H02P 6/08; H02P 6/18; H02M 1/32

(52) U.S. Cl. CPC H02M 1/44; H02M 1/32; H02P 6/18; H02P 6/085

(57) ABSTRACT

An electronically commuted (EC) motor includes an electromagnetic interference (EMI) filter circuit, a bridge circuit, an alternating current (AC) voltage to square wave circuit, a microcontroller, a motor coil, and a power circuit. The EMI filter circuit is for filtering out electromagnetic interference of an alternating current (AC) voltage received from a live line and a neutral line to generate a filtered AC voltage. The bridge circuit is for converting the filtered AC voltage to a first direct current (DC) voltage. The waveform converter circuit is for generating a pair of signals according to a voltage on the neutral line and a signal on the signal line. The microcontroller is for generating a control signal according to the pair of signals. The power circuit is for providing power to the motor coil according to the first DC voltage and the control signal.

### CROSS REFERENCE TO RELATED APPLICATIONS

This application claims the benefit U.S. provisional application No. 62/754,498, filed on Nov. 1, 2018 and incorporated herein by reference.

### BACKGROUND OF THE INVENTION

### 1. Field of the Invention

The present invention is related to an electronically commuted motor, especially to a three-mode selection electronically commuted motor with only three lead wire connection.

### 2. Description of the Prior Art

Electronically commuted (EC) motors are permanent magnet brushless DC (BLDC) motors that are being distinguished by their method of commutation (i.e. electronic) rather than by their physical characteristic of lacking brushes. These motors have a permanent magnet rotor with a wound stator. Electronics determine the sequence for commutation, or energizing of the stator windings, based on the rotor position, which is most often provided by either three Hall sensors or a rotary encoder. EC motors have no brushes, avoiding the sparking and short life of brushed motors. Because they have electronics controlling the stator and do not need to waste power inducing the rotor field, they give better performance and controllability, and run cooler than induction motors. EC motors are used today in many fractional-horsepower applications where high motor efficiency, reliability, and controllability are desired.

Conventionally, an EC motors with a live line and a neutral line is powered by an alternating current power supply. A signal line can be connected to either the live line or the neutral line to generate two different operation modes. In order for an EC motor to fully function like an alternating current induction motor, three modes of operating are needed. The present invention brings a new type of EC motor that has three operation modes.

### SUMMARY OF THE INVENTION

The embodiment provides an electronically commuted (EC) motor including an electromagnetic interference (EMI) filter circuit, a bridge circuit coupled to the EMI filter circuit, waveform converter circuit coupled to the neutral line and a signal line, a microcontroller coupled to the waveform converter circuit, a motor coil, and a power circuit coupled to the bridge circuit. The EMI filter circuit is for filtering out electromagnetic interference of an alternating current (AC) voltage received from a live line and a neutral line to generate a filtered AC voltage. The bridge circuit is for converting the filtered AC voltage to a first direct current (DC) voltage. The waveform converter circuit is for generating a pair of signals according to a voltage on the neutral line and a signal on the signal line. The microcontroller is for generating a control signal according to the pair of signals. The power circuit is for providing power to the motor coil according to the first DC voltage and the control signal.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of an electronically commuted (EC) motor of an embodiment.

FIG. 2 is a diagram showing a first operation mode of the EC motor of an embodiment.

FIG. 3 a diagram showing a second operation mode of the EC motor of an embodiment.

FIG. 4 a diagram showing a third operation mode of the EC motor of an embodiment.

FIG. 5 is a diagram of the waveform of the operation mode of the embodiment of FIG. 2.

FIG. 6 is a diagram of the waveform of the operation mode of the embodiment of FIG. 3.

FIG. 7 is a diagram of the waveform of the operation mode of the embodiment of FIG. 4.

### DETAILED DESCRIPTION

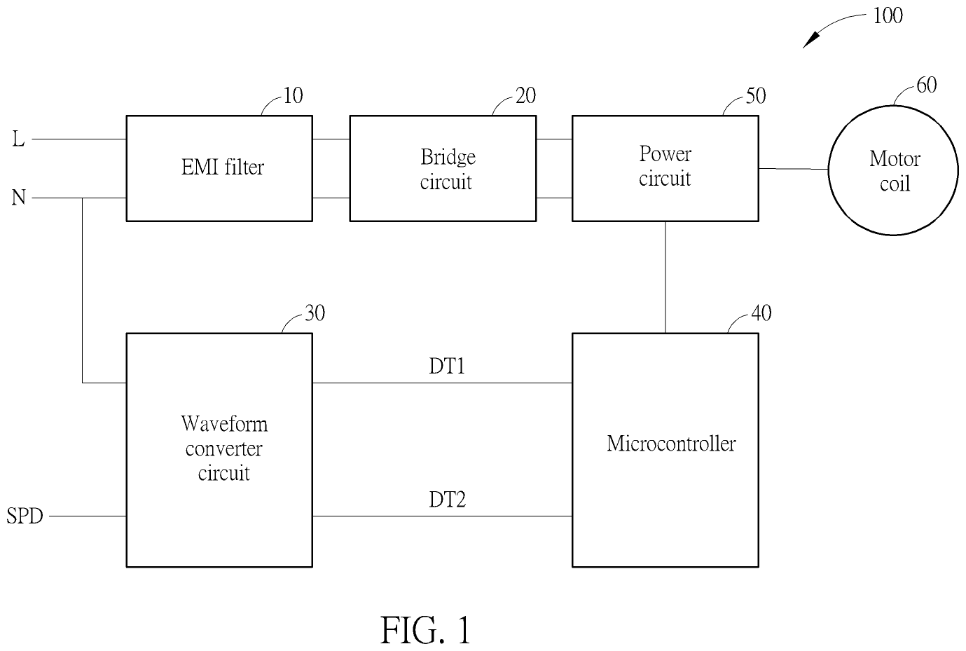

FIG. 1 is a diagram of an electronically commuted (EC) motor 100 of an embodiment. The EC motor 100 comprises an electromagnetic interference (EMI) filter circuit 10, a bridge circuit 20 coupled to the EMI filter circuit 10, a waveform converter circuit 30 coupled to a neutral line N and a signal line SPD, a microcontroller 40 coupled to the waveform converter circuit 30, and a power circuit 50 coupled to the bridge circuit 20, the microcontroller 40 and a motor coil 60. The EMI filter circuit 10 is for filtering out electromagnetic interference of an AC voltage received from a live line L and the neutral line N to generate a filtered AC voltage. The bridge circuit 20 is for converting the filtered AC voltage to a first direct current (DC) voltage. The waveform converter circuit 30 is for generating a pair of low voltage signals DT1, DT2 according to a voltage on the neutral line N and a signal on the signal line SPD. The microcontroller 40 is for generating a control signal according to the pair of low voltage signals DT1, DT2. The power circuit 50 is for providing power to the motor coil 60 according to the first DC voltage and the control signal.

The waveform converter circuit 30 is coupled to the neutral line L and the signal line SPD and generates the first low voltage signal DT1 and the second low voltage signal DT2. This can provide the microcontroller 40 three operation modes. The operation mode can be determined by the input connections. In some embodiments, the waveform converter circuit 30 can be an AC voltage to square wave circuit for converting AC voltage to square waves.

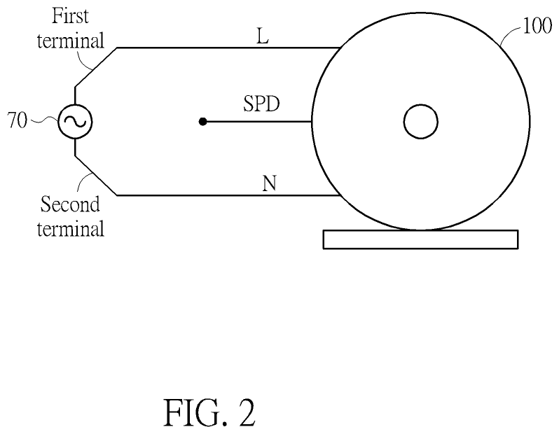

FIG. 2 shows a first operation mode of the EC motor of an embodiment. As illustrated in FIG. 2, the live line L and the neutral line N of the EC motor 100 are coupled respectively to a first terminal and a second terminal of an AC voltage source 70 and configured to output the AC voltage to the EMI filter 10 and the voltage on the neutral line L to the waveform converter circuit 30. The signal line SPD in this embodiment is floating.

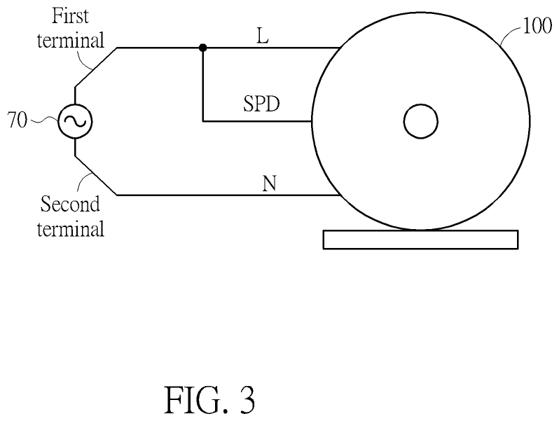

FIG. 3 shows a second operation mode of the EC motor of an embodiment. As illustrated in FIG. 3, the live line L and the neutral line N of the EC motor 100 are coupled respectively to the first terminal and the second terminal of the AC voltage source 70 and configured to output the AC voltage to the EMI filter 10 and the voltage on the neutral line to the waveform converter circuit 30. The signal line SPD in this embodiment is coupled to the live line L and the first terminal of the AC voltage source 70.

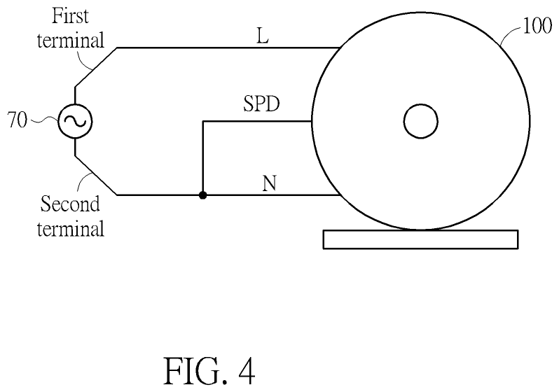

FIG. 4 shows a third operation mode of the EC motor of an embodiment. As illustrated in FIG. 4, the live line L and the neutral line N of the EC motor 100 are coupled respectively to the first terminal and the second terminal of the AC voltage source 70 and configured to output the AC voltage to the EMI filter 10 and the voltage on the neutral line to the waveform converter circuit 30. The signal line SPD in this embodiment is coupled to the neutral line N and the second terminal of the AC voltage source 70.

The operation modes are listed in Chart 1.

| | CHART 1 | | |
|---|---|---|---|
| | Input Connection | | |
| Modes | Live line L | Neutral line N | Signal Line SPD |
| First mode | First terminal | Second terminal | Floating |
| Second mode | First terminal | Second terminal | First terminal |
| Third mode | First terminal | Second terminal | Second terminal |

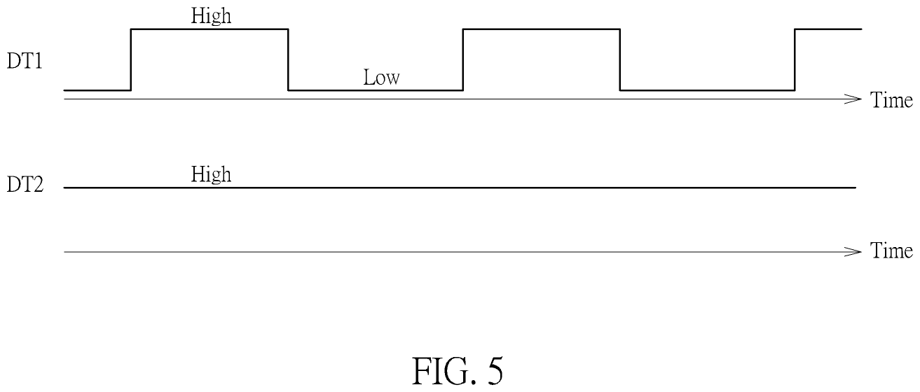

FIG. 5 is a diagram of the waveform of the operation mode of the embodiment of FIG. 2. For example, the AC voltage source 70 outputs the AC voltage with frequency of 60 Hz. When the live line L and the neutral line N are coupled respectively to the first terminal and the second terminal of the AC voltage source 70 and the signal line SPD is set to be floating, the first low voltage signal DT1 may be a 60 Hz square wave and the second low voltage signal DT2 may be a second DC voltage received by the waveform converter circuit 30. In this example, the second DC voltage may be 5V and the square wave may have a maximum voltage of 4V.

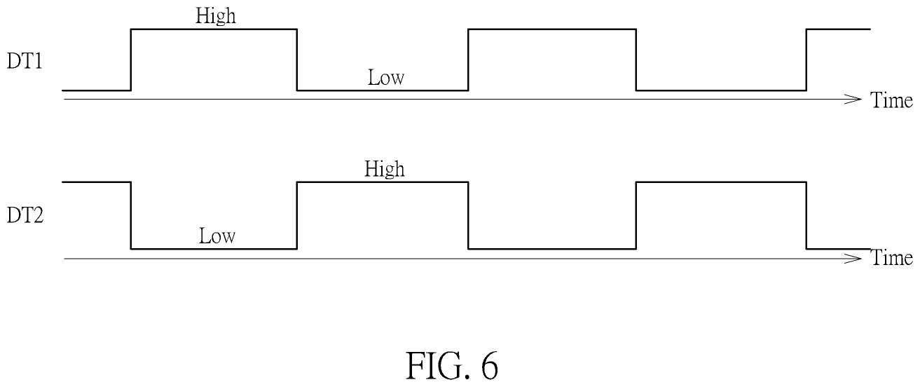

FIG. 6 is a diagram of the waveform of the operation mode of the embodiment of FIG. 3. For example, the AC voltage source 70 outputs the AC voltage with frequency of 60 Hz. When the live line L and the neutral line N are coupled respectively to the first terminal and the second terminal of the AC voltage source 70 and the signal line SPD is coupled to the live line L and the first terminal of the AC voltage source 70, the first low voltage signal DT1 may be a 60 Hz square wave and the second low voltage signal DT2 may be a square wave with the same amplitude as the first low voltage signal DT1 but reverse in phase. In this example, both square waves may have a maximum voltage of 4V.

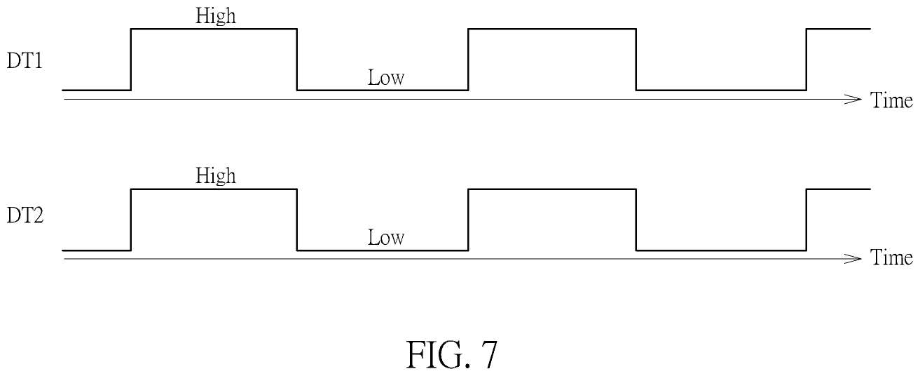

FIG. 7 is a diagram of the waveform of the operation mode of the embodiment of FIG. 4. For example, the AC voltage source 70 outputs the AC voltage with frequency of 60 Hz. When the live line L and the neutral line N are coupled respectively to the first terminal and the second terminal of the AC voltage source 70 and the signal line SPD is coupled to the neutral line N and the second terminal of the AC voltage source 70, the first low voltage signal DT1 may be a 60 Hz square wave and the second low voltage signal DT2 may be the same 60 Hz square wave with the same amplitude and the same phase. In this example, both square waves may have a maximum voltage of 4V.

The microcontroller 40 can control the power circuit 50 to create a controlled stator field to the motor coil 60 according to the first low voltage signal DT1 and the second low voltage signal DT2. Through the pair of low voltage signals DT1 and DT2, the rotational speed of the EC motor 100 can be controlled through the microcontroller 40 and the power circuit 50. For example, the three operation modes can be converted to three levels of rotational speed options. The first mode can be converted to a first rotational speed and the second mode can be converted to a second rotational speed . . . etc. This design achieves additional speed levels without additional circuits outside of the EC motor 100. Therefore, it simplifies the design and manufacturing process of the products comprising EC motors.

In summary, the EC motor of the embodiment of the present invention provides three operation modes and gives more flexibility in design and manufacturing for products comprising these EC motors. In addition, the implementation the EC motor of the embodiment mimics a conventional AC induction motor with three inputs. This allows the EC motor of the embodiment to have the function as the conventional AC motors while having the advantage of consuming less power than the conventional AC induction motors.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An electronically commuted (EC) motor comprising:
an electromagnetic interference (EMI) filter circuit configured to filter out electromagnetic interference of an alternating current (AC) voltage received from a live line and a neutral line to generate a filtered AC voltage;
a bridge circuit coupled to the EMI filter circuit and configured to convert the filtered AC voltage to a first direct current (DC) voltage;
a waveform converter circuit coupled to the neutral line and a signal line and configured to generate a pair of signals according to a voltage on the neutral line and a signal on the signal line;
a microcontroller coupled to the waveform converter circuit and configured to generate a control signal according to the pair of signals;
a motor coil; and
a power circuit coupled to the bridge circuit, the microcontroller, and the motor coil, and configured to provide power to the motor coil according to the first DC voltage and the control signal.

2. The EC motor of claim 1 wherein the waveform convert circuit is an alternating current (AC) voltage to square wave circuit.

3. The EC motor of claim 1 further comprising:
an AC voltage source coupled to the live line and the neutral line and configured to output the AC voltage to the EMI filter and the voltage on the neutral line to the waveform convert circuit.

4. The EC motor of claim 1 wherein when the signal line is not connected to the live line and the neutral line, the pair of signals comprises an AC voltage wave and a second DC voltage.

5. The EC motor of claim 1 wherein the signal line is coupled to the live line.

6. The EC motor of claim 5 wherein the pair of signals comprises two anti-phase waves.

7. The EC motor of claim 1 wherein the signal line is coupled to the neutral line.

8. The EC motor of claim 7 wherein the pair of signals comprises two in-phase waves.
